(19) United States
(12) Patent Application Publication
(10) Pub. No.: US 2007/0046470 A1
(43) Pub. Date: Mar. 1, 2007

(54) Hybrid Acousto-Magnetic Radio Frequency Transceiver Device

(76) Inventors: Mark Pempsell, Bedford, TX (US); Ryan Corley, Austin, TX (US)

Correspondence Address: BAKER BOTTS L.L.P., 2001 ROSS AVENUE, SUITE 600, DALLAS, TX, 75201-2980, US

(21) Appl. No.: 11/466,339

(22) Filed: Aug. 22, 2006

Related U.S. Application Data
(60) Provisional application No. 60/712,334, filed on Aug. 29, 2005.

(51) Int. Cl. G08B 13/14

(52) U.S. Cl. 340/572.1; 340/10.34; 340/10.5; 340/572.3

(57) ABSTRACT

In accordance with the teachings of the present invention, a hybrid acousto-magnetic radio frequency transceiver device is provided. In a particular embodiment, an electronic frequency transmitter includes an electronic transmitter producing a frequency of 58 KHz or as specified by user and synchronized at the proper level and repetition rate, a receiving coil to convert electromagnetic pulses or radio frequency radiant to electrical current, an electronic frequency transmitter with capability to adjust frequency carrier, an electronic frequency transmitter capable of transmitting programmed data bits or bytes, a receiving coil to convert electromagnetic or radio frequency radiant to electrical current, a transmitter antenna, a receiving antenna, and programmable input port.

### RELATED APPLICATION

This application claims the benefit of U.S. Provisional Application Ser. No. 60/712,334 filed Aug. 29, 2005.

### TECHNICAL FIELD OF THE INVENTION

The present invention relates generally to a means of combining an acousto-magnetic electronic article surveillance device and a radio frequency identification device in a singular form thereby allowing for multi-faceted item identification, traceability and security.

### BACKGROUND OF THE INVENTION

The problem of protection of articles of merchandise and the like against theft from manufacturing or distribution or retail stores has been the subject of numerous technical articles. Among these, an acousto-magnetic tag or marker is secured to an article to be protected. The tag responds to an interrogation signal from a transmitting apparatus situated either at the exit door of the premises to be protected, or at the aisle-way adjacent to the cashier or check out station. A receiving coil on the opposite side of the exit or aisle-way from the transmitting apparatus receives a signal produced by the tag in response to the interrogation signal. The presence of the response signal indicates that the tag has not been removed or deactivated by the cashier, and that the article bearing it may not have been paid for or properly checked out.

There is a rising use of the radio frequency identification (“RFID”) devices due in part to the retail outlets requiring their suppliers to provide such devices. When such a device is required by the supplier this is known as “source tagging”. By receiving inventory that has been integrally incorporated with the RFID tag it thus allows a retailer to precisely track from point of origins, their inventory from the receiving dock to the display area, completely through the point of sale or electronic article surveillance (“EAS”) interrogation gates. In the RFID scheme, the identifying device containing encoded information is placed on or in the goods or other items to be identified by an RFID reader. The encoded information is read by the reader with no user data entry generally required. The information encoded on the RFID tag is then typically passed to a processing medium for decoding. The content of the encoding consists of, but is not limited to, data bits of information of manufacturing tractability, inventory control, purchase price and in some cases the date of manufacturing or purchase.

Several different types of tags have been disclosed in literature and are in use. The acousto-magnetic type of marker consists of a first elongated element of high magnetic permeability ferromagnetic material disposed adjacent to at least a second element of ferromagnetic material having higher coercively than the first element. When subjected to the interrogation frequency of electromagnetic radiation, the tag causes harmonics of the interrogation frequency to be developed in the receiving coil.

Several different types of RFID tags have been disclosed in literature and are in use. In one type the apparatus is a passive RFID tag material tracking system capable of real-time location and identification of thousands of items in production and storage areas. Passive RFID tags are tracked by remote sensing antennas placed in locations to be monitored or scanning interrogators with several multiplexed antenna inputs are attached to sensing antennas and a computer which in turn communicates with interrogators thereby determining exact item location and quantity.

A second type of RFID tagging comes in the forms of an external activation or source active. The above mentioned devices are in an active state of data streaming transmission. In the active RFID scheme, the identifying device containing encoded information is placed on or in the goods or other items to be identified by an RFID reader. The encoded information is read by the reader with no user data entry generally required. The information encoded on the RFID tag is then typically passed to a processing medium for decoding. The content of the encoding consists of, but not limited to, data bits of information of manufacturing tractability, inventory control, purchase price and in some cases the date of manufacturing or purchasing.

Electronic article security and tracking systems of the type discussed above have been shown to be very effective in preventing the theft or unauthorized removal of articles, particularly articles that are small in size, easily concealed and relatively expensive. By means of tracking items from manufacturing to the point of sale is invaluable to both manufacturers and retail outlets.

### SUMMARY OF THE INVENTION

The present invention relates to a multi-function security tag representative in an electronic acousto-magnetic and electronic Radio frequency identification device combined in a single packaging format. This invention utilizes the latest in micro-electronic technology readily available to those skilled in the art to practice the invention. Therefore, the present invention is specifically designed to introduce EAS protection tag that in its present form will, when positioned within proximity of the interrogation gate transmit a signal at the same frequency as the readily available mechanical acousto-magnetic security tag. The second function of the tag emits a programmed encoded signal which is relative to the radio frequency identification device scheme. The identifying device containing encoded information is placed on items to be identified by an RFID reader. The content of the encoding consists of, but is not limited to, data bits of information of manufacturing traceability, inventory control, and purchase price and in some cases the date the device was manufactured or purchased.

This invention utilizes the latest in micro-electronic technologies readily available. The unique means of combining two distinct EAS systems: the acousto-magnetic (“AM”) and the radio frequency identification (“RFID”) device capable of operating as a security device when exposed to an EAS interrogation gate along with the capability to be programmed with encoded data bits and read by an RFID reader. The acousto-magnetic portion of the device consists of an electronic micro transmitter tuned to emit a 58 KHz or a “tower centric” signal as specified by the Consumer Product Manufacturers Association at amplitude sufficient to trigger an existing EAS interrogation gate. A component of the invention is an antenna sufficient in property to transmit the activation signal to the impending interrogation gate. This portion of the device includes a means to deactivate the interrogation field thus by disabling the unit from transmitting said signal. A receiving antenna is used to gather electromagnetic energy transmitted from the EAS interrogation gates located at the exit of retail outlets. The radio frequency identification device portion of the invention which when combined may be made without departing from the spirit or scope of the invention, but not limited to its entirety. The RFID portion of the invention consists of a receiving antenna used to gather energy tram an external source generated by means of a radio frequency identification reading device or can in its present form gather supply current by means of internal power source. This antenna when energized externally, win gather transmitted energy thereby converting said energy in a form suitable to power a micro-electronic circuit. An intricate portion of the invention consists of an electronic micro-transmitter adjustable to the frequencies and bit rate as specified by Consumer Product Manufacturers Association, manufacturers, OEM's, distributors, retailers, end users and the like. The present invention has an antenna sufficient to transmit the data bits produced by the micro-electronic RFID transmitter circuit.

The procedure of combining two distinct means of article identification and security in a single device utilizing both AM and RFID thereby providing a unique and inconspicuous means of item identification to reduce theft of merchandise at the point of manufacturing through retail sales.

Other technical advantages of the present invention may be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and features and advantages thereof, reference is now made to the following description, taken in conjunction with the accompanying drawings, in which:

FIG. 1 illustrates an electronic article surveillance tag in accordance with a particular embodiment of the present invention;

FIG. 2 illustrates an interrogation gate in accordance with a particular embodiment of the present invention; and

FIG. 3 illustrates an RFID transceiver in accordance with a particular embodiment of the present invention.

### DETAILED DESCRIPTION OF THE INVENTION

In the following detailed description of the preferred embodiments, reference is made to the accompanying drawings which form a part hereof; and in which is shown by way of illustration specific preferred embodiments in which the invention may be practiced. These embodiments are described in sufficient detail to enable those skilled in the art to practice the invention, and it is understood that other embodiments may be utilized and that logical mechanical, electrical and structural changes may be made without departing tram the spirit or scope of the invention. To avoid detail not necessary to enable those skilled in the art to practice the invention, the description may omit certain information known to those skilled in the art. The following detailed description is, therefore, not to be taken in a limited sense and the scope of the present invention is defined only by the appended claims.

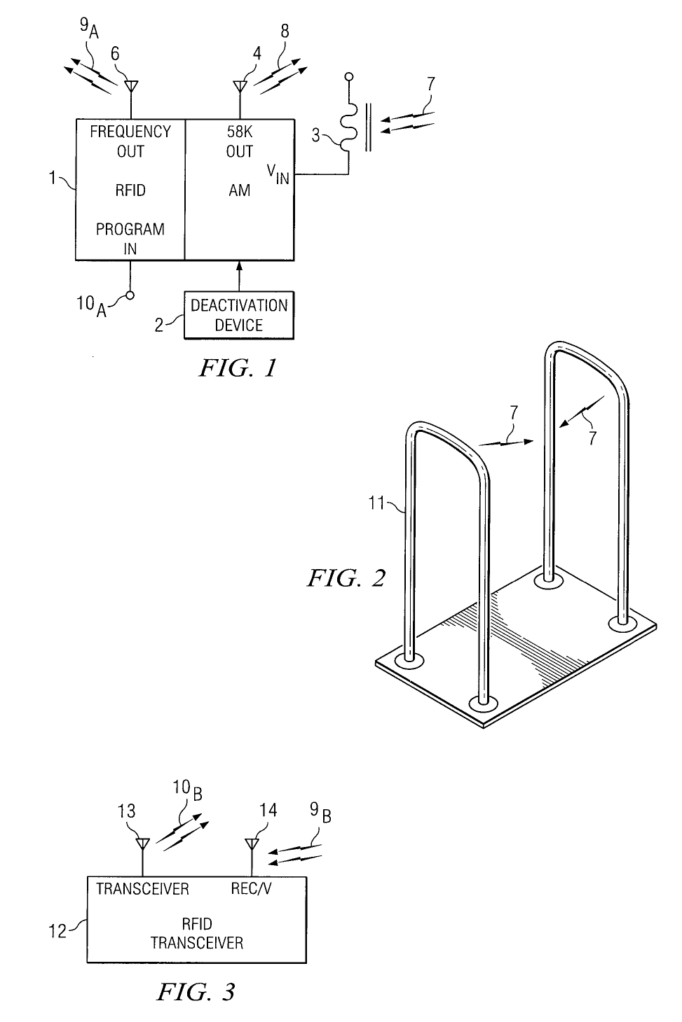

Referring to FIGS. 1, 2 and 3 wherein the same numeral designations are applied to corresponding numerals throughout the figures, an identification and security tag 1 according to the present invention is illustrated. The EAS tag 1 in FIG. 1 is comprised of two distinctive micro electronic circuits. One component of the EAS tag 1 is the acousto-magnetic frequency generator which when energized will transmit an alternating 58 KHz or equivalent signal 8 of sufficient amplitude and signal strength to trigger the EAS interrogation gate 11 in FIG. 2. The EAS interrogation gate 11 transmit an electrical signal 7 at the same time listening electronically for a matching signal 8. When the interrogation gate 11 receives a signal 8 of the same frequency, the alarm will sound. The EAS tag 1 in FIG. 1, consists of a receiving coil 3 which when introduced to the proximity of the interrogation gate 11 and its transmission frequency 7 will energize the coil 3 thus by supplying ample current to power the EAS tag 1. When the EAS tag 1 is energized it win transmit a signal 8 from the external antenna 4. The transmitted signal 8 can then be detected by the EAS interrogation gate 11 and the alarm will sound. When tagged item is properly obtained, the EAS tag 1 can be deactivated by means of an existing EAS magnetic deactivation magnet located at most cashier lines. The deactivation device 2 works in conjunction with the electronic EAS tag 1. The second component of the EAS tag 1 is a programmable micro electronic radio frequency identification transmitter. An RFID transmitter tag 1 in FIG. 1, is capable in its present form to receive data bits of information 10b transmitted by the RFID transceiver 12 in FIG. 3 by transmitter means 13 which then will be received by RFID transmitter 1 through input program port 10a. At the point that RFID transmitter 1 has received the data bit 10b program and the RFID transmitter tag 1 has been sufficiently energized through external source 7 to antenna 3, the RFID transmitter tag 1 will begin retransmitting data bits 10b through output antenna 13 with signal 9a. When in this state, RFID transceiver 12 of FIG. 3 will receive transmission signal 9a through receiving antenna 14 hereby known as received data bit transmission 9b. RFID transceiver 12 will decode transmission 9b and distribute this information in a form programmed to its specific specifications.

Although particular embodiments of the method and apparatus of the present invention have been illustrated in the accompanying drawings and described in the foregoing detailed description, it will be understood that the invention is not limited to the embodiments disclosed, but is capable of numerous rearrangements, modifications, and substitutions without departing from the spirit of the invention as set forth and defined by the following claims.

What is claimed is:

1. An electronic frequency transmitter comprising:
an electronic transmitter producing a frequency of 58 KHz or as specified by user and synchronized at the proper level and repetition rate;
a receiving coil to convert electromagnetic pulses or radio frequency radiant to electrical current;
an electronic frequency transmitter with capability to adjust frequency carrier;
an electronic frequency transmitter capable of transmitting programmed data bits or bytes;
a receiving coil to convert electromagnetic or radio frequency radiant to electrical current;
a transmitter antenna;
a receiving antenna; and
a programmable input port.
